(19) United States
(12) Patent Application Publication
(10) Pub. No.: US 2018/0332992 A1
(43) Pub. Date: Nov. 22, 2018

(54) Ornamental Hook System with Interchangeable Decorative Fixture

(71) Applicant: Howard Chong, Milpitas, CA (US)

(72) Inventor: Howard Chong, Milpitas, CA (US)

(21) Appl. No.: 15/983,797

(22) Filed: May 18, 2018

Related U.S. Application Data
(60) Provisional application No. 62/507,975, filed on May 18, 2017.

(51) Int. Cl. A47G 29/00; F16B 45/00; F16M 13/02

(52) U.S. Cl. CPC A47G 29/00; F16M 13/02; F16B 45/00

(57) ABSTRACT

A hook system is provided that includes a wall-mountable component and one or more interchangeable decorative fixtures. The wall-mountable component has a base, at least one hanger, and at least one stem/mounting arm having a distal end configured with an arm connection system. The decorative fixture includes a fixture connection system that correlates to the arm connection system, which together allow the decorative fixture to be attached and removed, thereby allowing a user to easily change the aesthetic appearance of the hook system to complement the room décor. Multiple connection systems are disclosed.

### CROSS-REFERENCE TO RELATED APPLICATIONS

This nonprovisional application claims the benefit of co-pending U.S. Provisional Patent Application Ser. No. 62/507,975, filed on May 18, 2017, which is incorporated herein in its entirety.

### FIELD OF INVENTION

This invention relates generally to hooks attachable to walls or other vertical surfaces, and, more particularly, to a hook system for clothes, hats, and other accoutrements with a lower hanger and an upper stem stem/mounting arm to receive an easily detachable and replaceable decorative fixture.

### BACKGROUND OF THE INVENTION

Hooks attached to walls have been popular for decades. These hooks provide a convenient holder to receive personal accoutrements, such as coats, hats, clothing, towels, keys, bags, and accessories. Conventionally, hooks come in varying sizes, styles, colors, and materials. The styles include single-prong hooks with a single hanger and multi-prong hooks with multiple hangers. Hooks are typically supported by a base to facilitate attachment to a wall. The base may be large or small. For example, it may provide a location through which one or more nails, screws, or other hardware may attach a single hanger to a wall, or it may include a rack or rail supporting several hangers with multiple locations along the rail to insert multiple attachment means. One or more hangers may be formed integrally with the base, or the hangers may be attached to the base, such as multiple hangers attached to a wooden base. The base is often designed to be decorative to enhance the look of the room.

Conventional hooks may have a base portion configured with one or more holes through which a screw (or a similar hardware device) is inserted. The distal threaded end of the screw is inserted into the hole, a screwdriver is inserted into a slot in the head of the screw, and the screw is driven into the wood of the wall (or into a specialized drywall anchor or receiver if the hook is to be installed into drywall). The head of the screw remains on the outward side of the base, thereby holding the hook in place with the hanger projecting outwardly from the base to receive one or more of various items.

Though conventional hooks are satisfactory for their intended purpose of holding various personal accoutrements, they provide limited decorative options and provide no means to change the style. If a user redecorates or desires a different look and feel for the room, the user must uninstall the hooks having the current style and reinstall other hooks with a different style. Not only is this troublesome, the wood or drywall to which the hook is attached is damaged during this procedure, and the new hooks will not be held as securely. Thus, the number of times that the hook style can be changed is quite limited.

Accordingly, there is a need for a hook system that not only allows a user to easily change from one style to a new style but does so without damaging the wall to which the hook is attached.

### BRIEF SUMMARY OF THE INVENTION

The present invention is directed to an ornamental hook system having a wall-mountable component and a decorative fixture, which is removably engageable with the wall-mountable component. The decorative fixture, which is positioned above the wall-mountable component, is interchangeable, thus increasing the usability and adaptability of the hook system.

The wall-mountable component comprises a base, at least one hanger supported on a lower part of the base, and a stem/mounting arm supported on an upper part of the base; the base, hanger, and stem/mounting arm may be separately or integrally formed. The upper portion of the stem/mounting arm is configured with an arm connection system. The decorative fixture comprises an outer decorative portion and a lower, centrally-disposed fixture connection system that correlates to, and connects to, the arm connection system. The fixture and arm connection systems work together to allow the user to easily remove a first fixture and attach a second fixture to accommodate a change in style, interest, or room décor.

Multiple means of attaching the decorative fixture to the stem/mounting arm of the wall-mountable component are herein disclosed. These include a snap-fit connection system of FIGS. 1, 5-7; a knob/channel connection system of FIGS. 2-4; a screw-type connection system of FIGS. 8-10; and a twist lock connection system of FIGS. 11-14. In each of the connection systems, the fixture connection system disposed within the lower central portion of the fixture engages with the arm connection system disposed at the distal (upper) end of the stem/mounting arm.

In one aspect of the invention, the base is a flat wall plate.

In an additional aspect of the invention, the base is a rack, rail, or wall plate supporting multiple hangers.

In another aspect of the invention, the base supports a single stem/mounting arm.

In a further aspect of the invention, the base supports multiple stem/mounting arms.

In another aspect of the invention, the ornamental hook system comprises a single fixture.

In an additional aspect of the invention, the ornamental hook system comprises a first set of fixtures and a second set of fixtures, each set of which is attachable to a set of hangers.

In a further aspect of the invention, the base, hanger, and stem/mounting arm of the wall-mountable component are integrally formed.

In another aspect of the invention, the base, hanger, and stem/mounting arm of the wall-mountable component are not integrally formed.

In an additional aspect of the invention, the base has holes for mounting to a wall.

In another aspect of the invention, the base has no holes, but is mounted to a wall via an adhesive or double-sided adhesive tape applied to the back of the base.

In a further aspect of the invention, the base and stem/mounting arm of the wall-mountable component are integrally formed, and the hanger is attached to the base.

In an additional aspect of the invention, the connection system is a knob/channel connection system.

In a further aspect of the invention, the connection system is a snap-fit connection system.

In another aspect of the invention, the arm connection system and the fixture connection system are threadingly engaged.

In an additional aspect of the invention, the connection system is a twist lock connection system.

The object of the invention is to provide a hook system having a decorative fixture attachment and to provide a method of use that gives an improved performance over the above described prior art systems and methods.

These and other objects, features, and advantages of the present invention will become more readily apparent from the attached drawings and from the detailed description of the preferred embodiments which follow.

### BRIEF DESCRIPTION OF THE SEVERAL VIEWS OF THE DRAWINGS

The preferred embodiments of the invention will hereinafter be described in conjunction with the appended drawings, provided to illustrate and not to limit the invention, where like designations denote like elements.

FIG. 1 is a front view of a first embodiment of the present invention having multiple hangers, multiple stem/mounting arms, and multiple attachable fixtures.

FIG. 2 is a side perspective view of a second embodiment of the present invention having a single hanger, single stem/mounting arm, and single insert (for inserting into a decorative fixture).

FIG. 3 is a cut view of a portion of the second embodiment taken along line 3-3 of FIG. 2.

FIG. 4 is an expanded perspective view of the second embodiment.

FIG. 5 is a side perspective view of the third embodiment of the present invention having a single hanger, single stem/mounting arm, and single insert.

FIG. 6 is a cut view of the upper portion of the third embodiment taken along line 6-6 of FIG. 5.

FIG. 7 is an expanded perspective view of the third embodiment.

FIG. 8 is a side perspective view of the fourth embodiment of the present invention having a single hanger, single stem/mounting arm, and single insert.

FIG. 9 is a cut view of the fourth embodiment taken along line 9-9 of FIG. 8.

FIG. 10 is an expanded perspective view of the fourth embodiment.

FIG. 11 is a side perspective view of the fifth embodiment of the present invention having a single hanger, single stem/mounting arm, and single insert.

FIG. 12 is a cut view of the fifth embodiment taken along line 12-12 of FIG. n.

FIG. 13 is a cut view of the insert of the fifth embodiment taken along line 13-13 of FIG. 11.

FIG. 14 is an expanded perspective view of the fifth embodiment.

Like reference numerals refer to like parts throughout the several views of the drawings.

### DETAILED DESCRIPTION OF THE INVENTION

Shown throughout the figures, the present invention is directed toward an ornamental hook system, shown generally as reference number 100, that includes a wall-mountable component 102 and an attachable and removable fixture 105, which allows a user to change the appearance of the hook system 100 without removing the wall-mountable component 102 from the wall. This is done by merely removing and replacing the decorative fixture 105 (such as a character, figure, artistic sculpture, statue, bust, representation, or the like) that is attachable to, and detachable from, the wall-mountable component 102. This allows the style of the hook system 100 to change as interests or room décor change. For example, the decorative fixtures 105 used in an infant's room may represent baby animal heads, which may be changed to characters from a favorite movie when the child becomes a toddler, and which may be changed again to sports-related representations when the child is older.

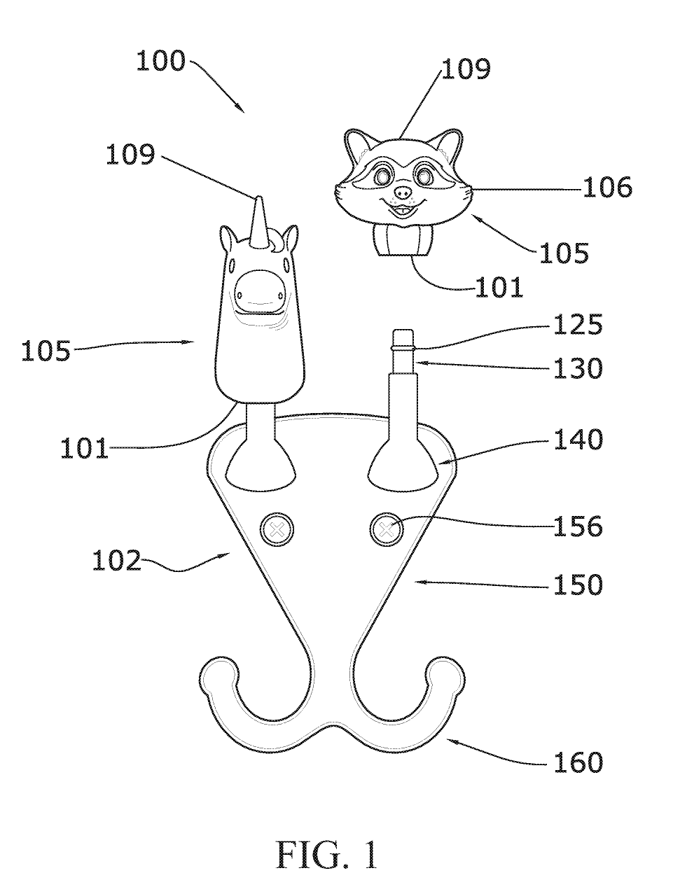

Referring now to FIG. 1, the ornamental hook system 100 is illustrated in accordance with a preferred first embodiment of the present invention. As shown, the ornamental hook system 100 comprises the wall-mountable component 102 configured to accept one or more removable and replaceable decorative fixtures 105. The wall-mountable component 102 comprises a base 150, at least one hanger 160, and at least one stem/mounting arm 140.

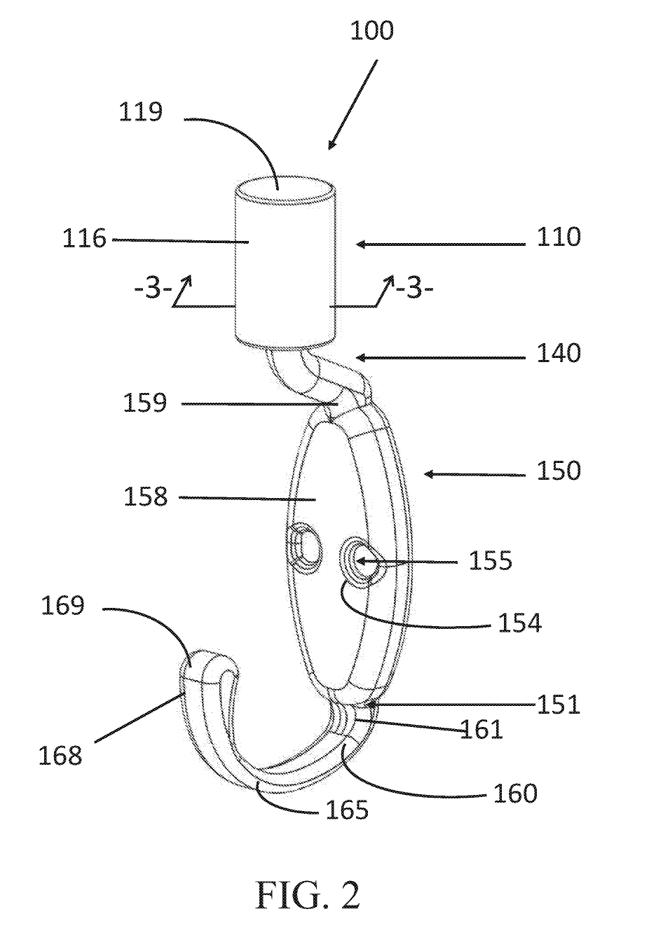

The base 150 is configured to allow attachment of the wall-mountable component 102 to a vertical surface, which is referred to generally herein as a “wall,” but includes other vertical surfaces such as cabinet fronts, mirrors, appliance façades, furniture front faces, and the like. The base 150 may be attached to the wall in any manner as is known in the art. In one aspect, the base 150 may have exposed holes 155 (FIG. 2) defined by hole edges 154 into which a screw 156 (FIG. 1), nail, or other hardware may be inserted to hold the wall-mountable component 102 to the wall. In another aspect, the base 150 may not have screw holes, but may instead be attached to the wall via adhesive or a double-sided adhesive tape disposed on the rear surface of the base 150. In a further aspect, the base 150 may be attached to the wall with hardware, but the hook system 100 may additionally include a separate or attached cover configured to fit over the hardware to give a more finished look.

As illustrated in FIG. 1, the base 150 may support multiple hangers 160, or, as shown in FIG. 2, the base 150 may support only a single hanger 160. The hanger 160 may take different shapes; it may be a peg, prong, knob, hook, or other projecting element onto which items may be hung. The shape and width of the base 150 may also vary widely based not only on the aesthetic look desired, but also on the number and size of the decorative fixtures 105 to be supported, on the number and size of hangers 160 to be supported, on the weight to be supported, and the like. For example, the base 150 illustrated in FIG. 1 has a generally triangular shape, while the base 150 illustrated in FIG. 2 has a generally oval shape to its front face 158. In FIG. 1, the base 150 has a width greater than the width of two decorative fixtures 105. The width of the base 150 is not required to be wider than the width of one or more decorative fixtures 105 (though shown in FIGS. 1 and 2 as wider than the decorative fixture(s) 105), but only needs to be sufficiently wide enough to support at least one hanger 160, to allow attachment to the wall, and to allow attachment and detachment of at least one decorative fixture 105.

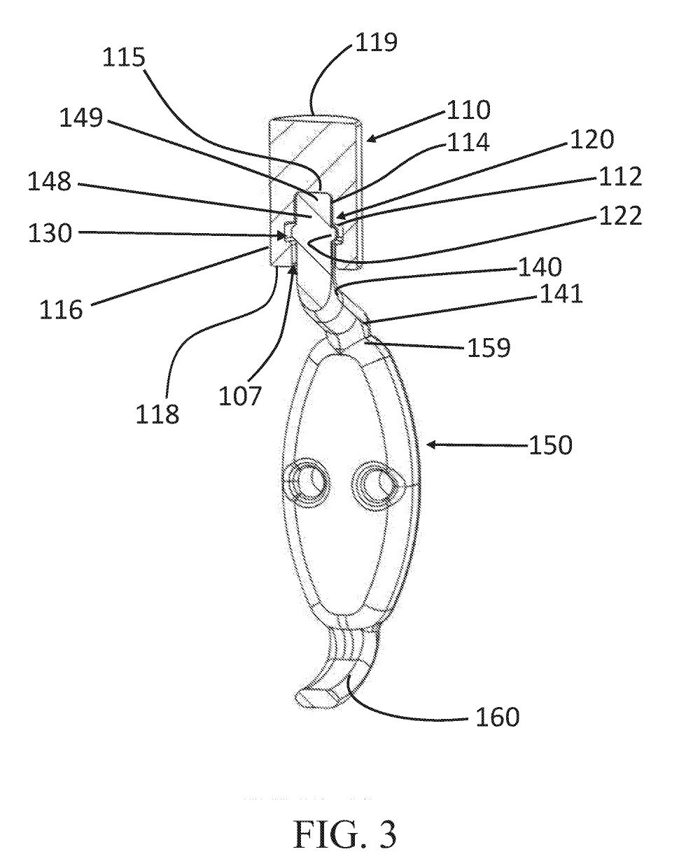

As illustrated in FIG. 1, the base 150 may form a foundation for multiple stem/mounting arms 140, or, as shown in FIG. 2, the base 150 may form a foundation for only a single stem/mounting arm 140. The wall-mountable component 102 includes one stem/mounting arm 140 for each decorative fixture 105. As seen in FIG. 3, the stem/mounting arm 140 comprises a proximal stem portion 141, a distal stem portion 149, an arm body portion 148 disposed between the proximal and distal stem portions 141, 149, and an arm connection system 120.

As seen in the cut view of FIG. 3, the stem/mounting arm 140 extends vertically and outwardly from a juncture location 159 of base 150. The juncture location 159 is disposed above the attachment area of the hanger 160. The juncture location 159 may be disposed at or near the top of the base 150, as seen in FIGS. 2-3, or may be disposed in locations above the midline of the base 150, as seen in FIG. 1. The stem/mounting arm 140 extends from the proximal stem portion 141 disposed at juncture location 159 upward and outward to the arm body portion 148 that ends at distal stem portion 149. The distance between the wall and the center of the arm body portion 148 when the hook system is installed must be sufficient to allow the attachment of the decorative fixture 105 to the distal end of the stem/mounting arm 140. In some aspects, such as when the decorative fixture 105 is threadingly engaged, the distance between the wall and the center of the distal stem portion 149 will be at least slightly over half the width of the decorative fixture 105 at its widest point. The arm body portion 148 is preferably, but not necessarily cylindrical.

The stem/mounting arm 140 is configured to receive the decorative fixture 105 with the arm connection system 120 of the stem/mounting arm 140 engageable with the correlating fixture connection system 130 of the decorative fixture 105. Any of a variety of types of connection systems are suitable for allowing the decorative fixture 105 to be removably attachable to the stem/mounting arm 140 of the wall-mountable component 102.

The decorative fixture 105 comprises a fixture bottom 101 (FIG. 1), an outer decorative portion 106, a fixture top 109, and an inner fixture connection system 130 (FIG. 3), which is disposed within the lower portion of the decorative fixture 105. The decorative fixture 105 extends from the fixture bottom 101 (FIG. 1) upwardly to the fixture top 109. The fixture connection system 130 is configured to engage with the correlating arm connection system 120 to hold the decorative fixture 105 in position on the stem/mounting arm 140 and is additionally configured to be manually disengaged from the arm connection system 120. The inner portion of the fixture connection system 130 is sufficiently large to conceal all or most of the arm connection system 120.

The decorative fixture 105 is in the form of a three-dimensional figure that may take the form of a character, figurine, artistic sculpture, statue, bust, geometric shape, representation of a naturally-occurring or manmade figure or article, or other decorative element. The decorative fixture 105 may be formed of plastic, wood, metal, paperboard, or of a combination of materials. The material may be colored before the creation of the figure, the outer decorative surface 106 may be painted after forming the shape, or the fixture may be molded of colored plastic with additional color applied after forming. Preferably the decorative fixture 105 is formed of plastic.

In an aspect, the decorative fixture 105 also comprises an inner insert 110. In the aspect having an inner insert 110, the fixture connection system 130 is disposed within the inner insert 110, as shown in FIGS. 2-3, while in the aspect without an inner insert 100 the fixture connection system 130 is disposed within the interior of the decorative fixture 105. As seen in FIG. 3, the insert 110 includes an insert body 116 that extends from an insert bottom 118 to an insert top 119. The insert body 116 has an inner opening 107 defined by an inner wall 114 and a top wall 115. The fixture inner opening 107 is sized and shaped to receive the upper portion of the stem/mounting arm 140. In the aspects in which the arm body portion 148 is cylindrical, the inner opening 107 will likewise be cylindrical. The insert body 116 has an outer surface, which may be adhesively fixedly attached to the walls of a central hole within the decorative fixture 105. The central hole of the decorative fixture 105 corresponds in size and shape to the outer surface of insert body 116, which is shown in FIGS. 2-3 as a cylinder shape. In this aspect, an insert 110 can be manufactured that can be fixedly attached to multiple shapes and types of outer decorative portions 106, which may provide efficiencies in manufacturing.

The hanger(s) 160 may be any type of hanger as is known in the art and may be curved, as illustrated, or straight. The hanger(s) 160 attaches to the base 150 at a hanger juncture location 151 and extends outwardly (and usually downwardly) from hanger juncture location 151. The hanger(s) 160 comprises a proximal portion 161 (FIG. 2), an outwardly extending medial portion 165, a distal portion 168, and a hanger end 169. The proximal portion 161 is attached at the hanger juncture location 151 to base 150. Preferably the proximal portion 161 is permanently attached to, or formed integrally with, the base 150.

The wall-mountable component may be formed of plastic, wood, metal, or combinations of materials. The elements of the wall-mountable component (base 150, arm 140, and hanger 160) may be formed of the same materials and may be formed integrally or separately and then connected. Or the elements of the wall-mountable component may be formed of different materials. For example, the base 150 may be formed of wood, the hanger 160 may be formed of metal, and the arm 140 may be formed of plastic. In another example, the base 150 and arm 140 may be formed integrally of metal, and the hanger 160 may be a wooden dowel attached to the base 150.

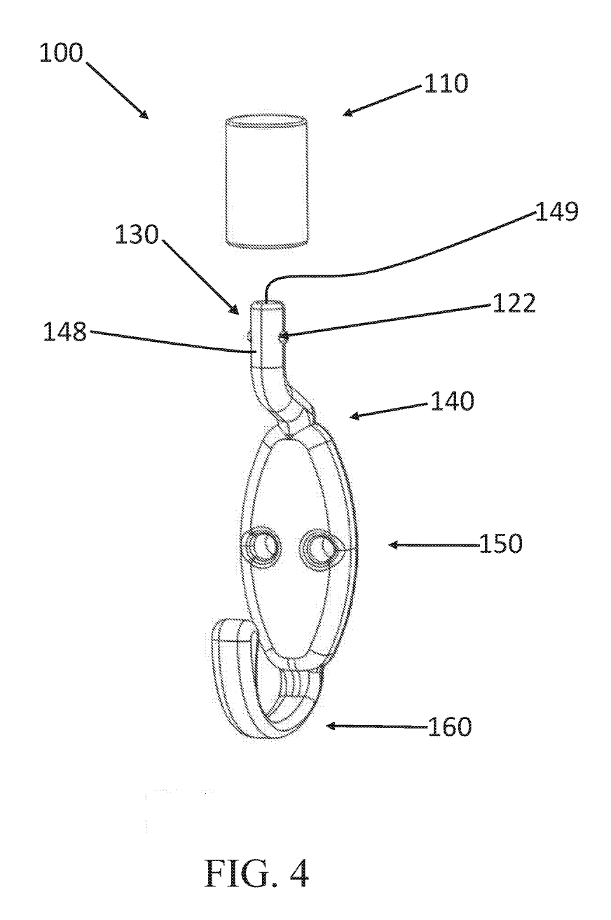

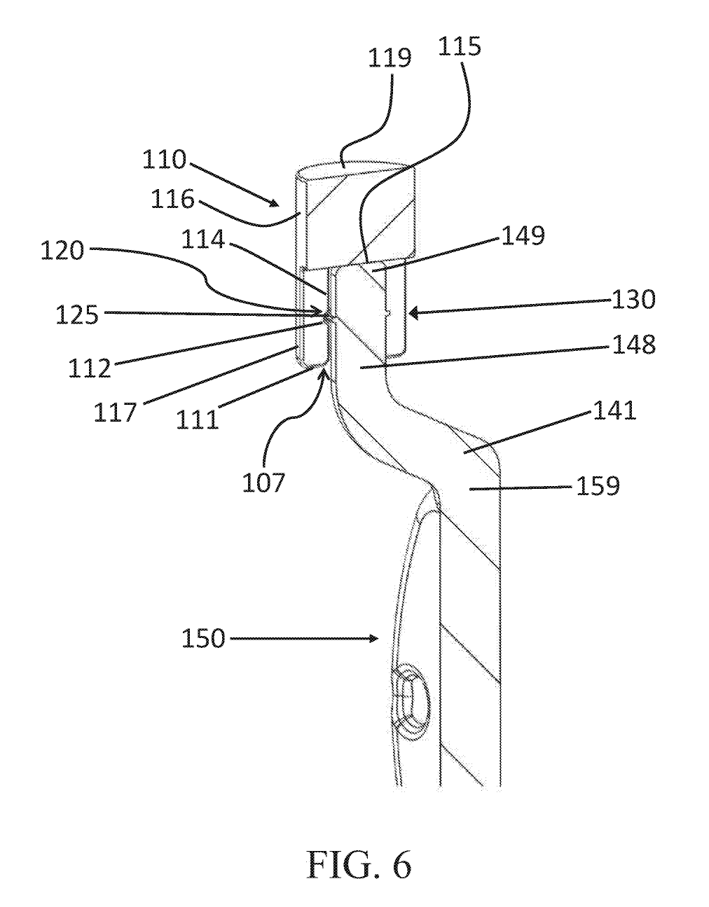

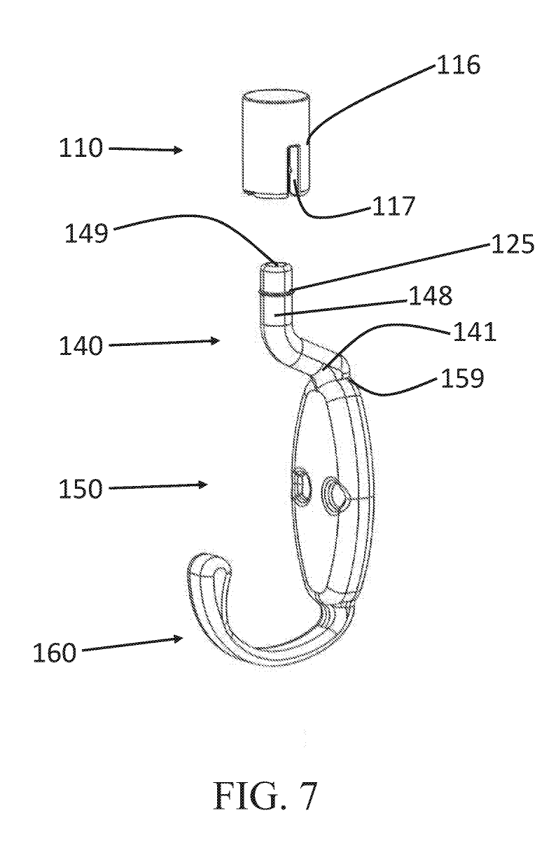

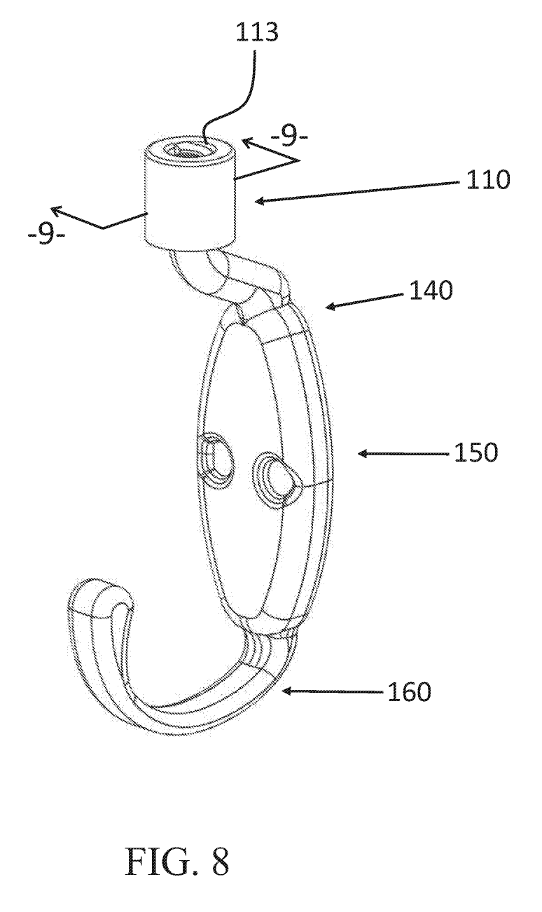

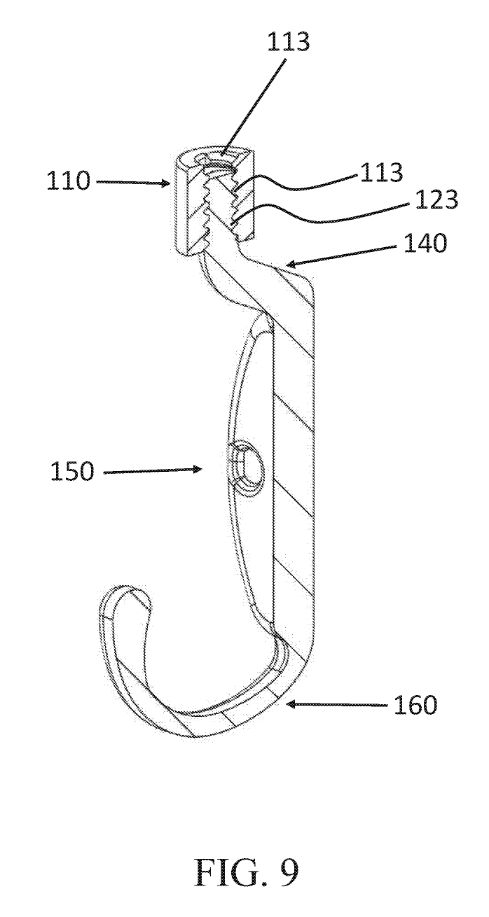

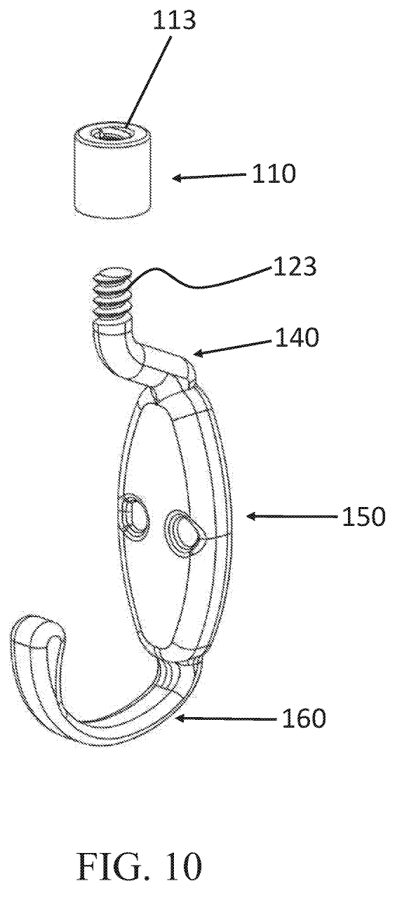

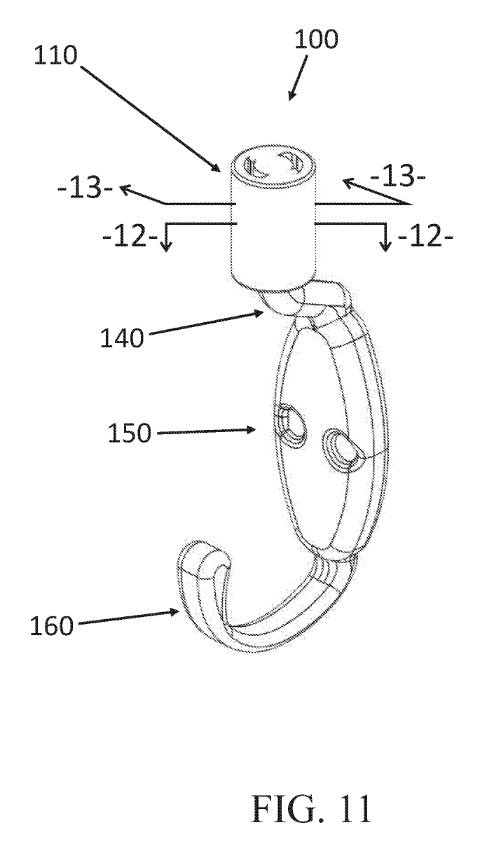

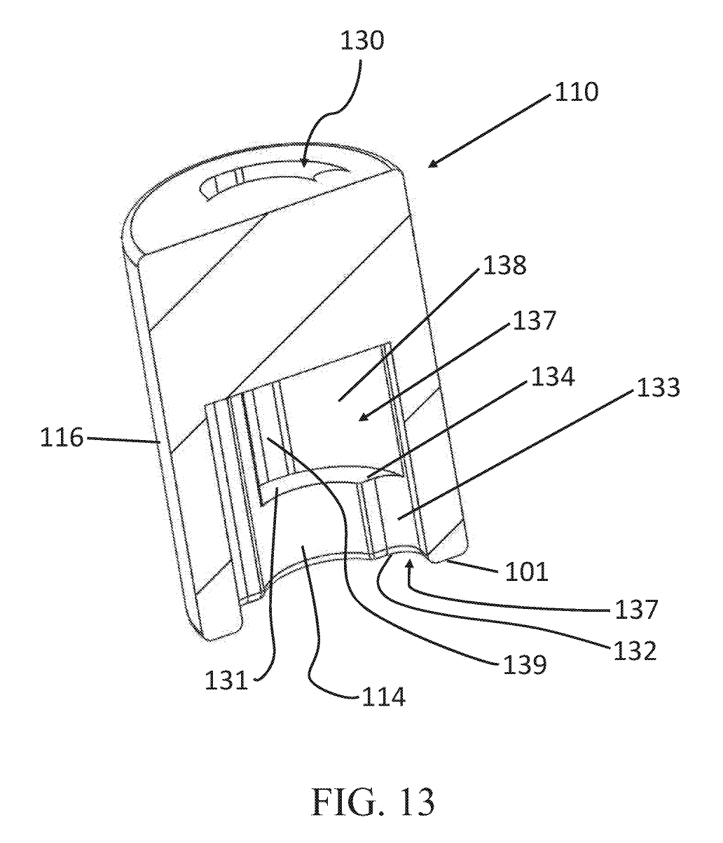

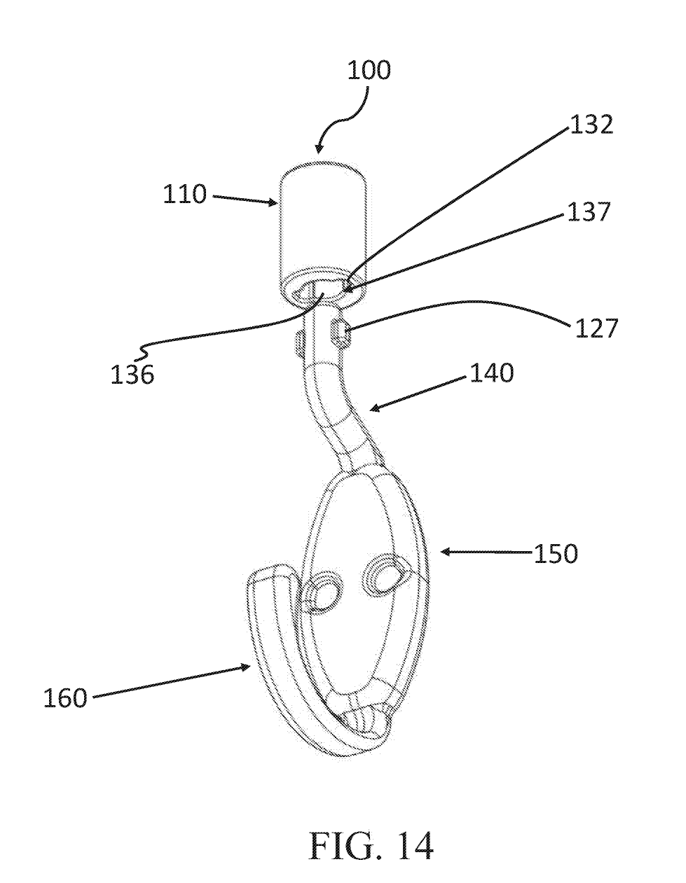

Turning now to the variations of the arm connection system 120 and correlating fixture connection system 130, FIGS. 2-4 illustrate a knob/channel connection system, FIGS. 1, 5-7 illustrate a snap-fit connection system; FIGS. 8-10 illustrate a screw-type connection system; and FIGS. 11-14 illustrate a twist lock connection system. In the knob/channel connection system, the snap-fit connection system, and the twist lock connection system the exterior of the stem/mounting arm 140 is configured with a connection extending portion and the interior of the fixture body 106 or the insert body 116 is configured with a connection concave portion that receives and accommodates the connection extending portion.

In the aspect shown in FIGS. 2-4, the connection systems 120, 130 are of the knob/channel type. The arm body portion 148 is preferably cylindrical (but may take other shapes), and there are at least two knobs 122 projecting outwardly beyond the outer circumference of the arm body portion 148, which form the connection extending portion. The knobs 122 are on opposite sides on the arm body portion 148. (Though illustrated as opposing and inline, knobs 122 need not be directly opposing each other, but should be spaced at least one third of the circumference or perimeter apart.) The arm connection system 120 (which may be disposed within an insert 110 for attachment within the decorative fixture 105 or may be disposed within the interior of the decorative fixture 105 itself) comprises an annular channel 112 that is inset into the inner wall 114 of the decorative fixture 105 or the decorative fixture insert 110 and that forms the connection concave portion.

The distance between the outer surface of the decorative fixture 105 (or of the decorative fixture insert 110) and the inner wall 114 is necessarily larger than the depth of channel 112. The diameter of the inner receiving hole 107 defined by inner wall 114 and top wall 115 is necessarily larger than the diameter of the arm body portion 148 of the stem/mounting arm 140 to allow insertion of at least the top of the arm body portion 148 into the inner receiving hole 107. Both inner receiving hole 107 and arm body portion 148 are preferably cylindrical but may be formed in other shapes. The vertical height of the hole 107 is sufficient to conceal the arm connection system 120 of the arm body portion 148.

In the aspect in which the arm body portion 148 is cylindrical, the radius of the cylindrical arm body portion 148 is smaller than the distance between the outermost projecting portion of the knob 122 and the center of the arm body portion 148. The radius of the open cavity defined by the inner wall 114 is smaller than the distance between the outermost projecting portion of the knob 122 and the center of the arm body portion 148.

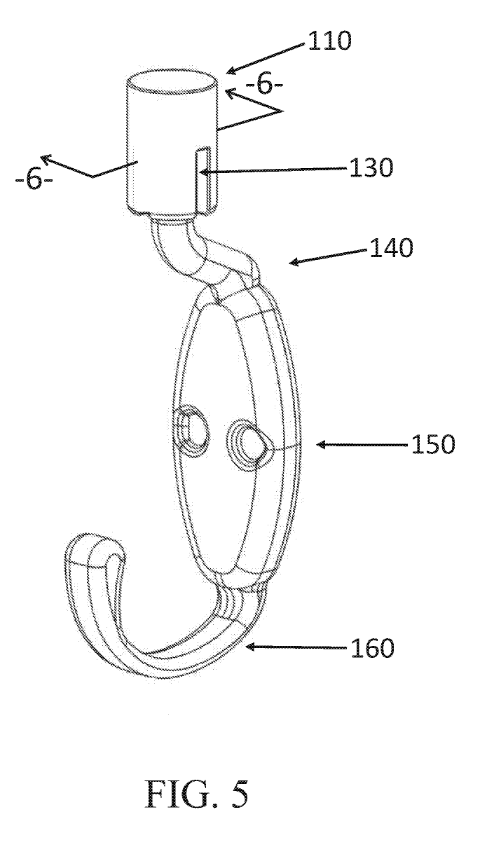

The knob 122 (and, in some aspects, the knob 122 and the body 148) may be formed of a material having enough give to allow the knob 122 to be manually pushed into the inner receiving hole 107 and to be seated in the annular channel 112. Optionally, a vertical slot 117 (as shown in FIG. 5) can be cut from the bottom edge 118 of the decorative fixture 105 or the insert 110 to the annular channel 112. In this aspect, the knob 122 may be inserted into the vertical channel to the depth of the channel 112 and then turned horizontally into the channel 112.

In the aspect shown in FIGS. 1, 5-7, the connection systems 120, 130 are of the snap-fit type. An annular ring 125 projects outwardly beyond the outer circumference of the (preferably cylindrical) arm body portion 148 of the stem/mounting arm 140. The annular ring 125 forms the connection extending portion.

The corresponding fixture connection system 130 is formed within the decorative fixture 105. Dual slots defined by slot vertical edges 117 and slot top edge 108 extend vertically from the bottom of the inner wall 114 to a depth above the annular ring 125. The dual slots are preferably disposed opposite one another. The slots allow a slight expansion at the lower portion of the inner receiving hole 107, which enables the manual insertion of the annular ring 125 into the annular channel 112.

As in the knob/channel connection system, the fixture connection system 130 (which may be disposed within an insert 110 attached to the decorative fixture 105 or may be disposed within the interior of a decorative fixture 105) comprises an annular channel 112 that is inset into the inner wall 114. In the snap-fit type connection system the fixture connection system 130 comprises the annular channel 112, which forms the connection concave portion.

In the aspect in which the inner wall 114 is cylindrical and defines a cylindrical open cavity, the diameter of the open cavity is smaller than the diameter of the arm body portion at the annular ring.

The annular ring 125 is pushed upward into the inner receiving hole 107 with the slots providing enough flexibility to allow the annular ring 125 to reach and frictionally engage with the annular channel 112. To detach the decorative fixture 105, the annular ring 125 is pulled downward, out of the channel 112, and out of the inner receiving hole 107.

In the aspect shown in FIGS. 8-10, the connection systems 120, 130 are of the screw-on type. The outer circumference of the cylindrical arm body portion 148 of the stem/mounting arm 140 is configured with outer stem threads 123. The inner wall 114 is configured with correlating fixture screw threads 113.

To install the decorative fixture 105 onto the top of the stem/mounting arm 140 of the base 150, the corresponding screw threads 113, 123 are engaged and the decorative fixture 105 is turned. To detach the decorative fixture 105, the decorative fixture 105 is turned in the reverse direction.

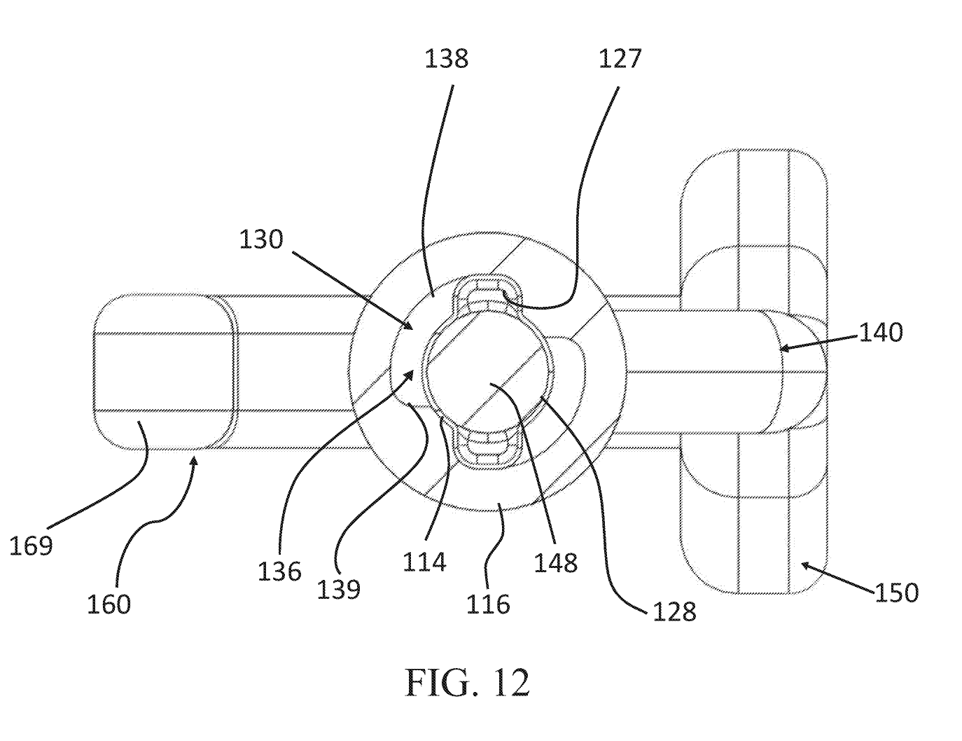

In the aspect shown in FIGS. 11-14, the connection systems 120, 130 are of the twist and lock type. Two opposing protrusions 127 (FIG. 12) project outwardly beyond the outer circumference of the cylindrical arm body portion 148 of the stem/mounting arm 140, which form the connection extending portion. The opposing protrusions 127 serve as the arm connection system 120 of the stem/mounting arm 140. The protrusion 127 may be thin and tab-like with a vertical height less than its circumferential width or may be a bulge or outcropping with a vertical height greater than or equal to its circumferential width.

The corresponding fixture connection system 130 is formed within the decorative fixture 105 or insert 110. Two partial circumferentially-extending passageways 136 defined by curved passageway walls 138, passageway top wall and passageway bottom wall 134, and a passageway end wall 139 extend horizontally and are inset within the inner wall 114, which form a connection concave portion. Each passageway can be visualized as a cut into or inset into the inner curved face of the inner wall 114. The passageway vertical height is sufficient to accommodate the vertical height of the protrusion 127. The distance between the inner wall 114 and the outer surface of the fixture body 106 or insert body 116 is greater than the distance between the curved passageway walls 138 and the outer surface of the fixture body 106 or insert body 116, in other words, the wall behind the passageways is thinner.

Each of the two opposing passageway open spaces 136 is in communication with a vertical open space of a conduit 137. The conduit 137 is an opening extending upwardly from the conduit bottom edge 132 at the bottom 101 of the decorative fixture 105 or of the decorative fixture insert 110 to the bottom wall 134 of passageway 136. The conduit 137 has a back wall 133, which is preferably curved. The distance between the inner wall 114 and the outer surface of the fixture body 106 or insert body 116 is greater than the distance between the conduit back wall 133 and the outer surface of the fixture body 106 or insert body 116. The two conduits 137 are disposed on opposite sides of the inner wall 114.

To use the twist and lock connection system to connect the decorative fixture 105 to the stem/mounting arm 140, the two opposing outwardly-projecting protrusions 127 are inserted into the bottom of the two opposing conduits 137, pushed upward through the conduits 137 and into the passageway open spaces 136, and twisted horizontally to position the protrusions 127 toward the passageway end wall 139. To remove the decorative fixture 105, these steps are reversed.

The invention illustratively disclosed herein suitably may be practiced in the absence of any element which is not specifically disclosed herein.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A hook system, comprising:
a wall-mountable component comprising a base, a hanger disposed on the lower portion of the base, a stem/mounting arm disposed on the upper half of the base, and an arm connection system disposed at the distal portion of the stem/mounting arm; and
a first decorative fixture comprising an external decorative surface, a fixture body, and a fixture connection system, wherein the fixture connection system correlates to the arm connection system to removably attach the first decorative fixture to the wall-mountable component.

2. The hook system as recited in claim 1, wherein the first decorative fixture further comprises an insert fixedly connected within the lower portion of the fixture body, wherein the insert comprises an insert body and an insert outer surface, wherein the fixture connection system is centrally disposed at the bottom of the insert body.

3. The hook system as recited in claim 1, wherein:
the stem/mounting arm comprises an arm body portion and a connection extending portion projecting outwardly from the arm body portion to form the arm connection system; and
the first decorative fixture comprises a fixture inner wall defining an open inner cavity and configured with a connection concave portion to form the fixture connection system.

4. The hook system as recited in claim 2, wherein:
the stem/mounting arm comprises an arm body portion and a connection extending portion projecting outwardly from the arm body portion to form the arm connection system; and
the insert comprises an insert inner wall defining an open inner cavity and configured with a connection concave portion to form the fixture connection system.

5. The hook system as recited in claim 3, wherein:
the connection extending portion of the stem/mounting arm comprises a first knob projecting outwardly from the arm body portion and a second knob projecting outwardly from the arm body portion; and
the connection concave portion of the first decorative fixture comprises an inset channel.

6. The hook system as recited in claim 4, wherein:
the connection extending portion of the stem/mounting arm comprises a first knob projecting outwardly from the arm body portion and a second knob projecting outwardly from the arm body portion; and
the connection concave portion of the insert comprises an inset channel;
wherein the first knob and the second knob are sized and shaped to fit within the inset channel.

7. The hook system as recited in claim 3, wherein:
the arm body portion is cylindrical; wherein the connection extending portion of the stem/mounting arm comprises an annular ring projecting outwardly from the cylindrical arm body portion; and
the connection concave portion of the first decorative fixture comprises an inset channel; wherein the annular ring is sized and shaped to fit within the inset channel.

8. The hook system as recited in claim 4, wherein:
the arm body portion is cylindrical; wherein the connection extending portion of the stem/mounting arm comprises an annular ring projecting outwardly from the cylindrical arm body portion; wherein the diameter of the cylindrical arm body portion is smaller than the diameter at the annular ring;
the connection concave portion of the insert comprises an inset channel; wherein the annular ring is sized and shaped to fit within the inset channel; and
the insert further comprises a proximal lower edge and opposing slots defined by slot vertical edges and a slot top edge, wherein the slots are disposed within the insert body and extend from the proximal lower edge to above the annular ring.

9. The hook system as recited in claim 3, wherein:
the connection extending portion of the stem/mounting arm comprises a first opposing protrusion and a second opposing protrusion projecting outwardly from the arm body portion; and
the connection concave portion of the first decorative fixture comprises a first partial circumferentially-extending passageway connected to a first vertical conduit and comprises a second partial circumferentially-extending passageway connected to a second vertical conduit; wherein the first opposing protrusion is sized and shaped to fit within the first conduit and the first passageway; and wherein the second opposing protrusion is sized and shaped to fit within the second conduit and the second passageway.

10. The hook system as recited in claim 4, wherein:
the connection extending portion of the stem/mounting arm comprises a first opposing protrusion and a second opposing protrusion projecting outwardly from the arm body portion; and
the connection concave portion of the insert comprises a first partial circumferentially-extending passageway connected to a first vertical conduit and comprises a second partial circumferentially-extending passageway connected to a second vertical conduit; wherein the first opposing protrusion is sized and shaped to fit within the first conduit and the first passageway; and wherein the second opposing protrusion is sized and shaped to fit within the second conduit and the second passageway.

11. The hook system as recited in claim 1, wherein:
the stem/mounting arm comprises an arm body portion configured with external threads; and
the decorative fixture comprises a cylindrical fixture inner wall configured with correlating internal threads that allow the decorative fixture to be threadingly engaged with the arm body portion.

12. The hook system as recited in claim 2, wherein:
the stem/mounting arm comprises an arm body portion configured with external threads; and
the insert comprises a cylindrical insert inner wall configured with correlating internal threads that allow the decorative fixture to be threadingly engaged with the arm body portion.

13. The hook system as recited in claim 1, further comprising a second decorative fixture comprising a second external decorative surface, a fixture body, and a fixture connection system; wherein the arm connection system correlates to the fixture connection system to removably attach the second decorative fixture to the wall-mountable component.

14. The hook system as recited in claim 13, wherein the second external decorative surface is not identical to the first external decorative surface.

15. A hook system, comprising:
a wall-mountable component comprising a base, a hanger disposed on the lower half of the base, a stem/mounting arm disposed on the upper half of the base, and an arm connection system disposed at the distal portion of the stem/mounting arm; wherein the stem/mounting arm comprises a cylindrical arm body portion and a connection extending portion projecting outwardly from the arm body portion to form the arm connection system; and
a decorative fixture comprising an external decorative surface, a fixture body, a fixture connection system, and an insert; wherein the arm connection system correlates to the fixture connection system to removably attach the decorative fixture to the wall-mountable component; wherein the insert is fixedly connected within the lower portion of the fixture body; wherein the insert comprises an insert body and an insert outer surface; wherein the fixture connection system is centrally disposed at the bottom of the insert body; and wherein the insert comprises a cylindrical inner wall defining an open inner cavity and configured with a connection concave portion to form the fixture connection system.

16. The hook system as recited in claim 15, wherein:
the connection extending portion of the stem/mounting arm comprises a first knob projecting outwardly from the arm body portion and a second knob projecting outwardly from the arm body portion; wherein the radius of the cylindrical arm body portion is smaller than the distance between the outermost projecting portion of the first knob and the center of the arm body portion; and wherein the radius of the arm body portion is smaller than the distance between the outermost projecting portion of the second knob and the center of the arm body portion; and
the connection concave portion of the insert comprises an inset channel; wherein the first knob and the second knob are sized and shaped to fit within the inset channel; and wherein the diameter of the open cavity defined by the cylindrical inner wall is smaller than the distance between the outermost projecting portion of the first knob and the center of the arm body portion plus the distance between the outermost projecting portion of the second knob and the center of the arm body portion.

17. The hook system as recited in claim 15, wherein:
the connection extending portion of the stem/mounting arm comprises an annular ring projecting outwardly from the arm body portion; wherein the diameter of the arm body portion is smaller at the cylindrical portion than the diameter of the arm body portion at the annular ring;
the connection concave portion of the insert comprises an inset channel; wherein the annular ring is sized and shaped to fit within the inset channel; and wherein the diameter of the open cavity defined by the cylindrical inner wall is smaller than the diameter of the arm body portion at the annular ring; and
the insert further comprises a proximal lower edge and opposing slots disposed within the insert body and extending from the proximal lower edge to above the annular ring.

18. The hook system as recited in claim 15, wherein:
the connection extending portion of the stem/mounting arm comprises a first opposing protrusion and a second opposing protrusion projecting outwardly from the arm body portion; wherein the diameter of the arm body portion is smaller at the cylindrical portion than the distance between the outermost projecting portions of the opposing protrusions; and
the connection concave portion of the insert comprises a first partial circumferentially-extending passageway connected to a first vertical conduit and a second partial circumferentially-extending passageway connected to a second vertical conduit; wherein the first opposing protrusion is sized and shaped to fit within the first conduit and the first passageway; and wherein the second opposing protrusion is sized and shaped to fit within the second conduit and the second passageway.

19. A hook system, comprising:
a wall-mountable component comprising a base, a hanger disposed on the lower half of the base, a stem/mounting arm disposed on the upper half of the base, and an arm connection system disposed at the distal portion of the stem/mounting arm; wherein the stem/mounting arm comprises an arm body portion and a connection extending portion projecting outwardly from the arm body portion to form the arm connection system; and
a decorative fixture comprising an external decorative surface, a fixture body, and a fixture connection system; wherein the arm connection system correlates to the fixture connection system to removably attach the decorative fixture to the wall-mountable component; wherein the fixture connection system 130 is centrally disposed at the bottom of the fixture body; and wherein the decorative fixture comprises a cylindrical inner wall defining an open inner cavity and configured with a connection concave portion to form the fixture connection system.

20. The hook system as recited in claim 19, wherein:
the connection extending portion of the stem/mounting arm comprises a first opposing protrusion and a second opposing protrusion projecting outwardly from the arm body portion; wherein the diameter of the arm body portion is smaller at the cylindrical portion than the distance between the outermost projecting portions of the opposing protrusions; and
the connection concave portion of the decorative fixture comprises a first partial circumferentially-extending passageway connected to a first vertical conduit and a second partial circumferentially-extending passageway connected to a second vertical conduit; wherein the first opposing protrusion is sized and shaped to fit within the first conduit and the first passageway; and wherein the second opposing protrusion is sized and shaped to fit within the second conduit and the second passageway.
